(19) United States
(12) Patent Application Publication
(10) Pub. No.: US 2008/0150294 A1
(43) Pub. Date: Jun. 26, 2008

(54) Centrifugally active variable magnetic flux alternator

(76) Inventor: Steven Mark Jones, Mason, NH (US)

Correspondence Address: Steven Mark Jones, 346 Old Ashby Road, Mason, NH, 03048, US

(21) Appl. No.: 11/998,378

(22) Filed: Nov. 28, 2007

Related U.S. Application Data
(60) Provisional application No. 60/861,698, filed on Nov. 29, 2006.

(51) Int. Cl. H02P 9/04; F03D 9/00; H02K 9/19; H02K 16/00; H02K 7/02; H02K 1/27

(52) U.S. Cl. 290/55; 310/54; 310/114; 310/74; 310/156.01; 290/44

(57) ABSTRACT

Today modern large commercial wind turbines enable large quantities of electrical power diverted from the wind. The short comings are that they need a pitch control mechanism to turn the turbine blades to capture to wind at different angles on the surface area of the blades.
This is feature is mostly due to the inadequacies of the conventional generator technology. The Centrifugally Active Variable Flux Generator features moveable permanent magnets that enable variable magnetic flux control that can automatically control the amount of magnetic flux to the stators by the annular velocity of the rotors, therefore control the amount of output electrical power in different wind speeds without the need for a pitch control system on the blades.
Modern wind turbines have pitch control system needed to keep the wind turbine operating in the proper rotor speed for efficiency. The present invention enables a wind turbine to be fitted with a fixed turbine blade without the need of a pitch control system. This will allow for reduction in manufacturing cost and repairs from the much economical blade design.

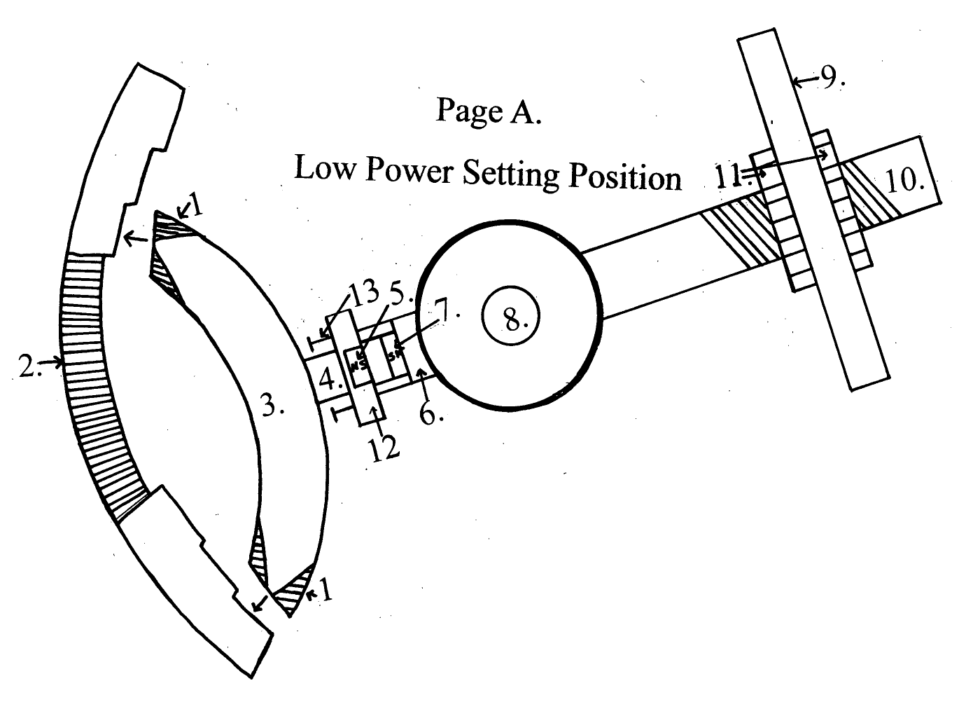

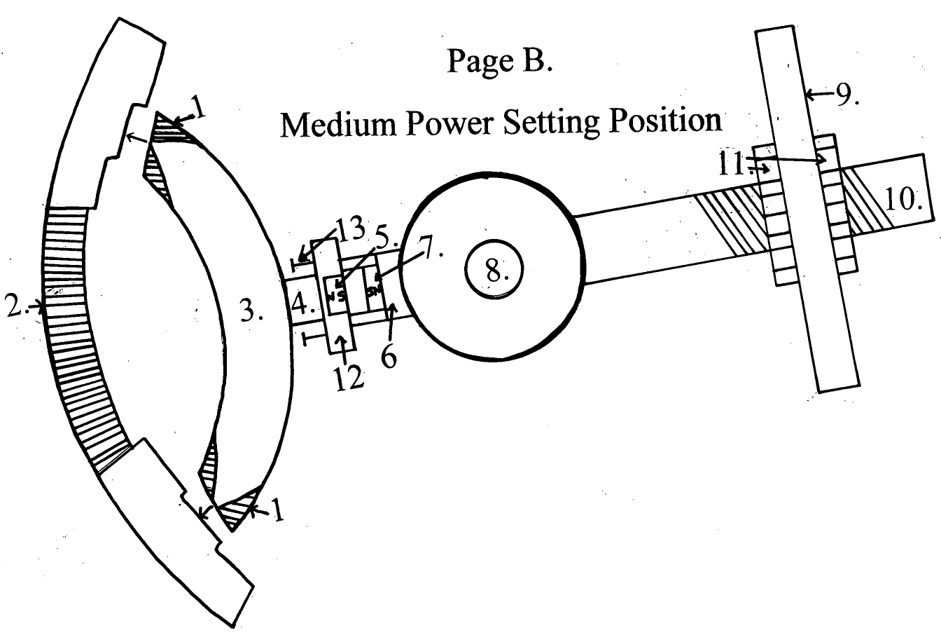

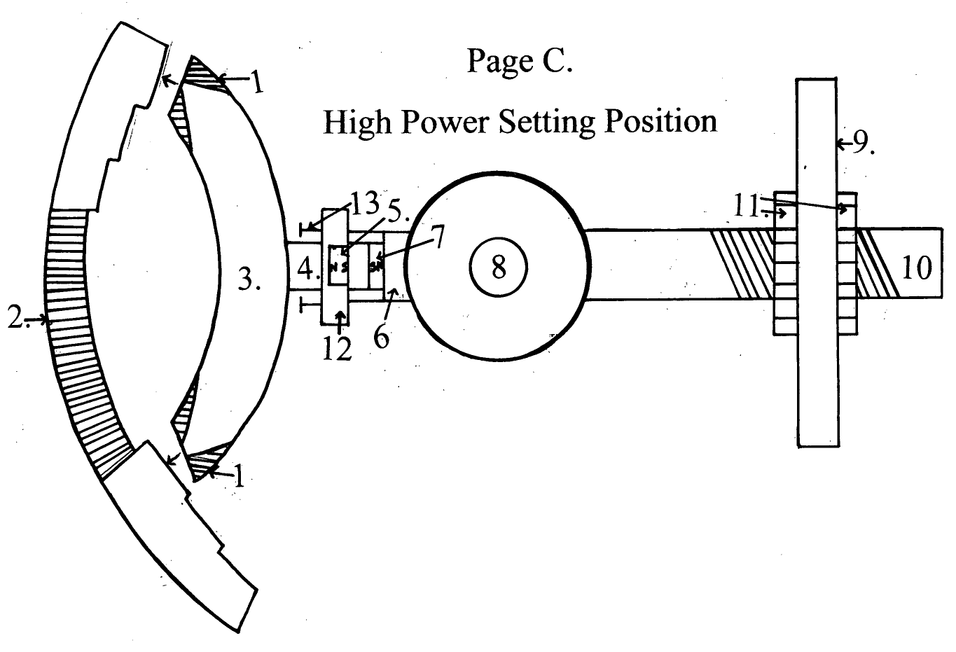

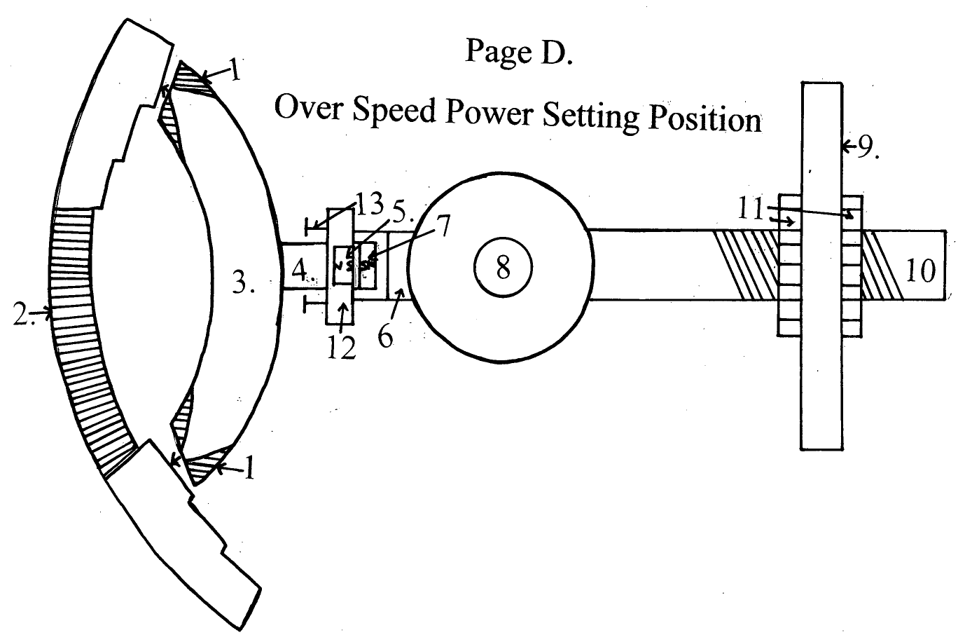

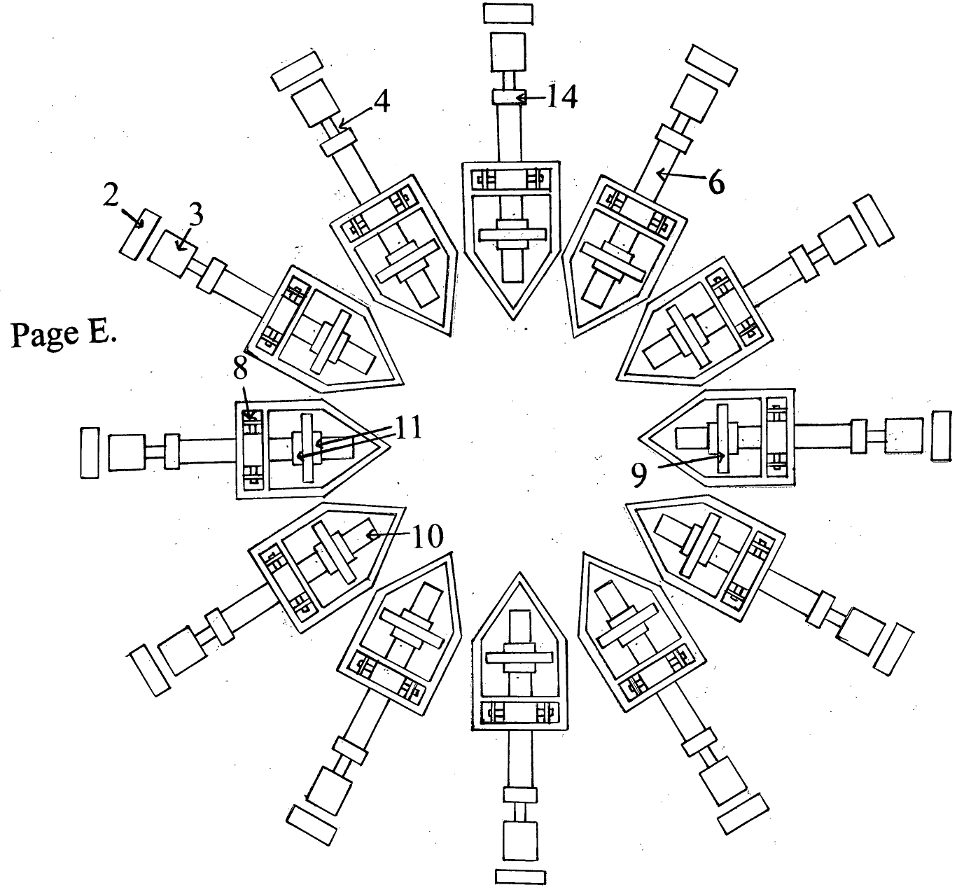

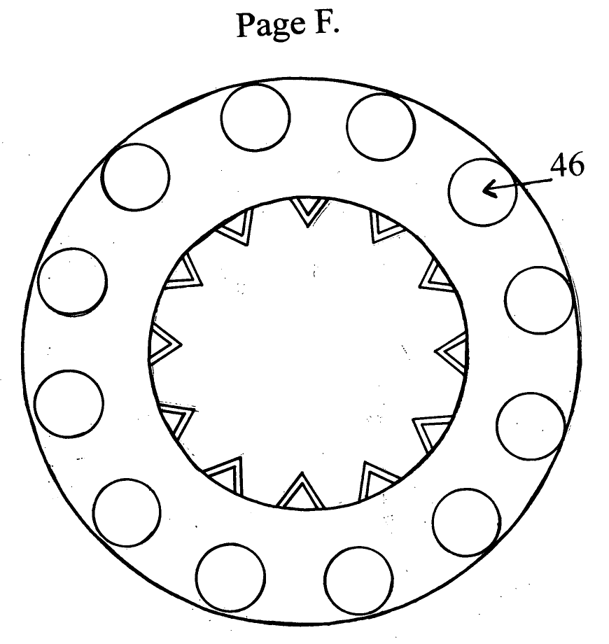

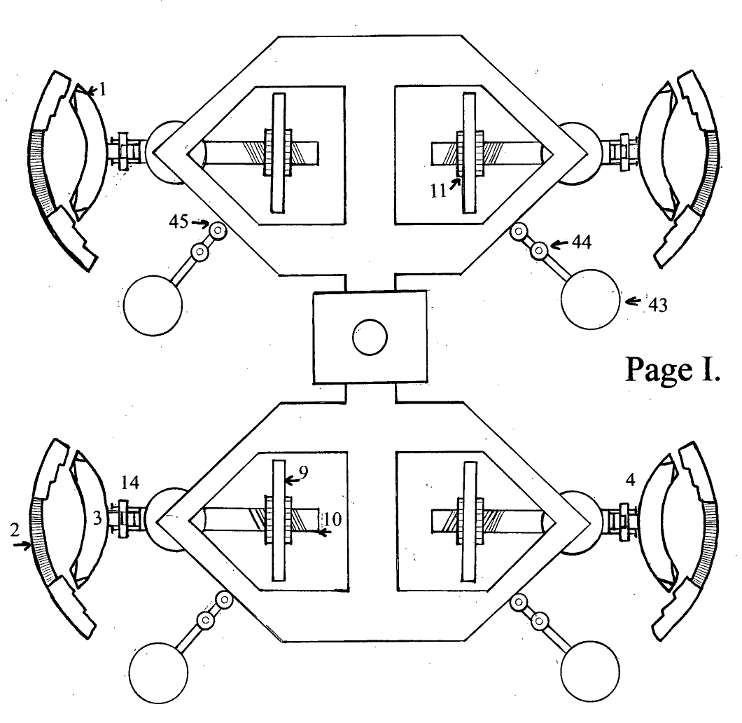

### CROSS-REFERENCE TO RELATED APPLICATIONS

This application is related to and claims priory from Provisional Patent Application Ser. No. 60/861,698 filed Nov. 29, 2006.

### SEQUENCE LISTING

“Not Applicable”

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER PROGRAM LISTING

“Not Applicable”

### BACKGROUND OF THE INVENTION

### 1. Field of the Invention

The present invention relates generally to a wind turbine alternator that is capable of maintaining and progressively increasing electrical output power to eliminate over speeding of the rotors by high wind conditions. The generator self regulates the magnetic flux density and back EMF accordantly, matching the present wind conditions by the annular velocity, centrifugal and gyroscopic forces placed on the two counter rotating rotors moveable magnets, revolving around the stators.

### BRIEF SUMMARY OF THE INVENTION

The present invention is an alternator having two stators in a stationary position, they are placed concentrically around the two counter rotating rotors center line, opposite their axis. The rotors have moveable permanent magnets that can be in conventional north-south or Halbach array configuration.

Centrifugal and gyroscopic forces placed on the rotors enable the moveable magnets to move up and down, by means of a fulcrum and counter balance type system, that allows the moveable magnets to change their location from below the centerline when stopped or low annular velocity of the rotors to upwards towards the centerline of the rotors when high annular velocity and centrifugal forces are placed on the rotors from the input shafts.

The moveable magnets allows the magnetic flux density and output electrical power levels to constantly change from low to high from the moveable magnets changing the air gap from large to progressively small in reference to the stator coils stationary position.

### BRIEF DESCRIPTION OF SEVERAL VIEWS OF THE DRAWING

The invention will be further described in the following, in a non-limiting way with reference to the accompanying drawings in which:

Page A: is a side view of the Centrifugally Active Variable Flux Generator configured according to the present invention, with the movable magnets (3) and the adjustable counter weights (9) in the low power setting position.

Page B: is a side view of the Centrifugally Active Variable Flux Generator configured according to the present invention, with the movable magnets (3) and the adjustable counter weights (9) in the medium power setting position.

Page C: is a side view of the Centrifugally Active Variable Flux Generator configured according to the present invention, with the movable magnets (3) and the adjustable counter weights (9) in the high power setting position.

Page D: is a side view of the Centrifugally Active Variable Flux Generator, with the movable magnets (3) and counter weights (9) in the high power setting position and the moveable magnets (3) and outer magnet holder shaft (4) move further away from the shaft bearing (fulcrum) (8) and closest distance to the stator coils (2) on the inner and outer magnet holder shafts (4-6). Forcing the two repelling magnets (5-7) together, this is the over speed protection mode.

Page E:

Top view of the Centrifugally Active Variable Flux Generator configured according to the present invention, comprising some of the internals, stator coils (2), moveable magnets (3), outer magnet holder shaft (4), inner magnet holder shaft (6), shaft bearing (8), adjustable counter weight (9), adjustable counter weight shaft (10), adjustable counter weight locking nut (11), top bearing (14).

Page F:

Bottom view of the Centrifugally Active Variable Flux Generator configured according to the present invention, with the rotors (29-30) and the pendulum lead weights (43).

Page I:

Side cut away view of the Centrifugally Active Variable Flux Generator configured according to the present invention showing its internal components.

### NUMBERED COMPONENTS ON DRAWINGS OF THE INVENTION

Components:
1. Magnetic shielding material
2. Stepped stator coils
3. Moveable magnets
4. Outer magnet holder shaft
5. Over speed outer magnet
6. Inner magnet holder shaft
7. Over speed inner magnet
8. Shaft bearing
9. Adjustable counter weight
10. Adjustable counter weight shaft
11. Adjustable counter weight locking nuts
12. Over speed protection device locking device to prevent over extension
13. Over speed protection device locking device to hold proper alignment
14. Over speed protection device
15. “Deleted”
16. “Deleted”
17. “Deleted”
18. “Deleted”
19. “Deleted”
20. “Deleted”
21. “Deleted”
22. Differential
23. Clockwise rotor input shaft
24. Counter clockwise rotor input shaft
25. Turbine blade input shaft
26. Clockwise rotor
27. Counter clockwise rotor
28. “Deleted”
29. Liquid cooled electronic control box
30. “Deleted”
31. “Deleted”
32. “Deleted”
33. “Deleted”
34. “Deleted”
35. “Deleted”
36. “Deleted”
37. “Deleted”
38. “Deleted”
39. “Deleted”
40. “Deleted”
41. “Deleted”
42. Main control panel
43. Pendulum lead weights
44. Middle pendulum bearing
45. Top pendulum bearing
46. Outside turbine blade
47. “Deleted”
48. “Deleted”
49. “Deleted”
50. “Deleted”
51. “Deleted”
52. “Deleted”
53. “Deleted”
54. “Deleted”
55. “Deleted”
56. “Deleted”
57. “Deleted”
58. “Deleted”

### DETAILED DESCRIPTION OF THE INVENTION

### Alternator Operation:

To fully explain the advantages of the Concepts/Technologies in the Next Generation Wind Turbine, there is a small comparison for reference:

### Conventional Wind Turbine Technology

### Undersized Alternator

If the wind turbine's alternator was undersized compared to the properly calculated blade swept area vs. alternator size. The wind turbine would start producing electrical power sooner than a larger sized alternator vs. the same blade swept area in extra low wind velocities. This configuration has a high thrust from the blades to low drag ratio from the magnetic induction.

In medium wind velocities the alternator would be operating near, or at full capacity. When the wind speeds are increased to high velocities, the wind turbine would start to over speed sooner than a larger sized alternator, due to the lack of resistance from the magnetic induction from the undersized alternator. The over speed device is then activated and the high-energy potential is then wasted.

### Medium Sized Alternator

If the wind turbine's alternator is properly matched (medium sized) to the calculated blade swept area vs. the alternator size. In extra low wind velocities, the alternator would not spin fast enough to produce useable electrical power compared to the undersized alternator mentioned previously. This lack of startup is from the increased magnetic induction (load on turbine blade input shaft) and the same input torque from the blade.

In medium wind velocities, the wind turbine would be properly matched putting out approximately the same electrical power as the undersized alternator at maximum output.

When approaching high speeds, the alternator would start to produce maximum electrical output. Then the over speed device would be activated when the turbine approaches the set maximum rotor RPM and the high-energy potential would be wasted.

### Oversized Alternator

If the wind turbines alternator is oversized vs. the blade swept area. In extra low wind velocities the alternator would not move, or move too slow to produce useable electrical power, due to the higher magnetic induction from the larger alternator. In medium wind velocities, the wind turbines would startup and produce a reasonable amount of electrical power.

When approaching high speeds or above, the wind turbine would provide higher electrical power levels than the two power modes previously mentioned. The wind turbine would not over speed, due to the higher braking action from Lenz's law (the physical resistance to magnetic induction) being applied to the rotors.

### Centrifugally Active Variable Magnetic Flux Alternator Operation:

It would be beneficial to have an alternator design that could operate at peak efficiency in extra low wind speeds like the undersized alternator. Then automatically change to operate like the properly sized alternator in medium wind speeds.

Then automatically change again to operate like an oversized alternator in high wind speeds and not waste the high potential energy from the wind by activating the over speed device.

This automatic compensating action is due to the centrifugally controlled movable magnets (3) matching the wind speeds at all times. Centrifugal forces are applied to the moveable magnets (3) from the increase or decrease of the rotors (26-27) rotational speed for proper positioning to the stepped stator coils (2) for proper loading to the rotors (3) and input shafts (23-24).

There are 12 moveable magnets (3) total in each one, of the two rotors (26-27). When looking at a side cut away view, each one of the two rotors (26-27) has six moveable magnets (3) that have a North Pole on the top and a South Pole on the bottom of the moveable magnets (3).

The other six moveable magnets (3) in each one of the two rotors (26-27), has a South Pole on the top and a North Pole on the bottom of the moveable magnets (3). The movable magnets (3) are equally spaced all around and changing magnetic poles every moveable magnet (3).

North pole on top and a South pole on bottom of the moveable magnet (3) then a South pole on top and a North pole on the bottom of the moveable magnet (3), ect all the way around to reverse the magnetic flux direction to the stepped stator coils (2) every time the moveable magnets (3) pass each one of the 12 stepped stator coils (2) in the two stators, to produce alternating current.

The alternating current output is controlled by the power conditioner to regulate the voltage, frequency, ect. This power conditioner is located in the main control panel (42).

There are 12 shaft bearings (8) that acts like fulcrums and there are 12 adjustable counter weights (9) opposite each of the 12 moveable magnets (3) in each on of the two rotors (26-27). There can be many more moveable magnets (3) and stepped stator coils (2) incorporated in each one of the two rotors (26-27) if it was but not limited to; an extra low speed design, any configuration would produce similar results. The adjustable counter weights (9) can be computer controlled or manually adjusted by the adjustable counter weight locking nut (11) then set.

The computer controlled system can determine the optimum rotor (26-27) rotational speed from the available wind and apply the appropriate magnetic flux density to the stepped stator coils (2) by moving the adjustable counter weights (9) back or forth to change the mechanical leverage on the shaft bearings (fulcrum) (8) that is placed between the moveable magnets (3) and the adjustable counter weights (9). The produced load from the magnetic induction is applied to the input shafts (24-25) for the maximum efficiency calculations.

The manual setting can be also set for maximum efficiency and completely rely on the rotors (26-27) rotational speed to control the amount of magnetic flux density to the stepped stator coils (2). Once the proper distance is set with the adjustable counter weights (9) in relation to the shaft bearing (8) (fulcrum), then the adjustable counter weight locking nuts (11) are tightened and set.

This movement of the mass ie: adjustable counter weights (9) moving closer and further away from the fulcrum ie: shaft bearing (8) in essence, controls the engagement speed and output electrical power level of the alternator by properly matching the available wind speed to the produced centrifugal force to the outer edge of the rotors (26-27) ie: moveable magnets (3) by the rotational velocity of the rotors (29-30).

Because the engagement and therefore the startup speed of the wind turbine can be internally adjusted and controlled from the adjustable counter weights (9) with the moveable magnets (3), there is no need for an external moving pitch blade control and external wind monitoring systems. This is a very expensive and weak link in the conventional upwind turbine design.

With the centrifugally controlled movable magnets (3) manipulating the amount of magnetic flux from the moveable magnets (3) to the stator coils (2) enables the means to self regulate the variable coil (2) resistance applied to the input shafts (24-25) connected to the rotors (26-27).

This automatic magnetic flux control capability, facilitates the undersized alternator mode in low wind conditions and changes to the medium sized alternator mode in moderate wind conditions to the oversized alternator mode in high wind conditions.

The Centrifugally Active Variable Magnetic Flux Alternator also possess the ability to change from the oversized generator mode in high wind conditions, down to the medium sized generator mode in medium wind conditions and down to the undersized generator mode in low wind conditions.

In a smooth automatically changing action by the centrifugally controlled movable magnets (3), providing variable coil (2) resistance to match the wind speed at all times.

The Centrifugally Active Variable Magnetic Flux Alternator functions like having 4 differently sized generators operating as one, without the power robbing variable speed input transmission system on conventional turbine designs.

Every power mode operates at peak efficiency (electrical output vs. mechanical input) at all times, similar to the operation of an automatic transmission in a motor vehicle which engages the proper gear ratio for each situation and maximizes the internal combustion engine's capabilities for maximum efficiency.

There are 4-power settings shown to assist in the explanation, but the design can be exploited to possess many more small increments of power modes if needed, to provide a constant increase or decrease in alternator power.

### Low Power Alternator

At extra low wind speeds the moveable magnets (3) are at the lowest power setting of it's variable range of motion and the minimum amount of magnetic flux density from the movable magnets (3) to the stepped stator coils (2).

At this power setting, the moveable magnets (3) are at the furthest distance away from the stepped stator coils (2). Therefore, the wind turbine can offer useable spin rates and appropriate electrical power in extremely low wind speed like it was attached to the undersized alternator (minimum resistance to the input shaft) previously mentioned.

### Medium Power Alternator

When the wind speed starts to increase, the blade swept area captures the wind energy and increases the alternator rotors (26-27) speed proportionally. This increased rotor (26-27) speed increases the centrifugal force placed on the moveable magnets (3).

The moveable magnets (3) start to move up and away from their lowest power setting on the stepped stator coils (2) and towards the middle power setting on the stepped stator coils (2), increasing the magnetic flux density from the movable magnets (3).

At this power setting the moveable magnets (3) are closer to the stepped stator coils (2), now operating like a medium sized alternator with an increased physical resistance from the magnetic induction. This power setting is the same as the properly sized single sized alternator vs. blade swept area (conventional wind turbine design).

### High Power Alternator

When the wind speeds approaches the high-speed velocities, the blade swept area captures the wind energy and again increases the alternator rotors (26-27) rotational speed proportional to the increase of wind velocity.

This increased rotor (26-27) annular velocity further increases the centrifugal force placed on the moveable magnets (3). Then they start to move away from the middle power setting on the stepped stator coils (2) and towards the highest power setting on the stepped stator coils (2), straight out along the lines of the rotors (26-27). Similar to a conventional alternator rotor configuration.

This in turn further increases the magnetic flux density to the stator coils (2) from the moveable magnets (3). At this power setting, the magnets are even closer to the stepped stator coils (2), now operating like an oversized alternator previously mentioned and further increasing the physical resistance to magnetic induction applied to the alternator rotors (large braking action).

### Extra High Power Alternator, Over Speed Protection:

When the wind speed is at an extremely high velocity, conventional wind turbine technology will be at the full over speed protection mode. The Centrifugally Active Variable Magnetic Flux Alternators moveable magnets (3) will already be at the highest position from the multiple positioning capabilities, to the stepped stator coils (2) (high power generator mode).

There is an over speed protection system incorporated in the initial alternator design, as well. If the rotor (26-27) rotational speed begins to exceed the continuous operational design safety RPM rating.

There will be greater centrifugal force applied to the moveable magnets (3) and the over speed protection device, compared to the high power generator mode from the increased rotor rotational speed. This device has over speed inner and outer magnets (5-7), connected to the inner magnet holder shaft (6) and the outer magnet holder shaft (4).

The over speed inner and outer magnets (5-7) are facing each other in the repulsion mode. The continuous operational design safety RPM rating is then calculated. In addition, the mass of the variable magnetic flux system with the moveable magnets (3) shaft bearing (8), adjustable counter weights (9) ect, the inner and outer magnet holder shaft (4-6) and the over speed inner and outer magnets (5-7) is then calculated to the set safety RPM.

This would provide the centrifugal force calculation pushing outward from the axis. Then the magnetic repulsion calculations from the over speed inner and outer magnets (5-7) will be set at that approximate FIGURE.

After the centrifugal force exceeds the set magnetic repulsion force from the increases rotor (26-27) speed, the outer magnet holder shaft (4) starts to “stretch” outward, beyond it's regular rotor (26-27) size used in the low-medium and high power settings.

This stretched rotor (26-27) size forces and places the repulsing over speed inner and outer magnets (5-7) even closer to each other, this places the moveable magnets (3) closer to the stepped stator coils (2) than where they were at the high power output setting on the stator coils (2).

This extra close air gap, moveable magnet (3) to stepped stator coil (2) setting produces the highest magnetic flux density from the moveable magnets (3) and produces the highest electrical output from the stator coils and places the highest amount of physical resistance to the magnetic induction (maximum braking action) to the rotors (26-27).

This mode enables the massive energy potential from the extremely high velocity winds to be converted to electrical power and not wasted in the conventional wind turbine over speed protection device.

Due to the fact that permanent magnets, magnetic flux density can not be controlled like an electromagnet, by varying the air gap between the moveable magnets (3) and the stepped stator coils (2) in essence, controls the amount of magnet flux density to the stator coils (2) from the moveable magnets (3).

Allowing full magnetic flux density control similar to an electromagnet with controls but with the increased efficiency of a permanent magnet design. The best of both alternator designs and capabilities are integrated in the Centrifugally Active Variable Flux Alternator.

Therefore, a wind turbine equipped with the Centrifugally Active Variable Magnetic Flux Alternator can produce even greater usable electrical power at all wind speeds compared to conventional wind turbines.

By producing electrical power in extra low wind speeds, before startup speed on conventional wind turbines and producing greater electrical power in high wind speeds when the conventional wind turbine designs are activating their over speed device and wasting this valuable high energy potential.

This invention allows the wind turbine to automatically adjust itself with maximum power potential in all wind speeds without pitch control and exceed the capable power levels of conventional wind turbines with pitch control from the conventional wind turbine technology.

### Gyroscopic Stabilization:

The Centrifugally Active Variable Magnetic Flux Alternator has two counter rotating flexible rotors (26-27), each one contains twelve movable magnets (3) located at the outer rim of the rotors (26-27) this design can be configured into many moveable magnets/coils as desired. The moveable magnets (3) exhibit a flexible outer rim design when they are spun at low-speed. Then the moveable magnets (3) exhibit a firm outer rim design, when they are spun at high-speed.

The Centrifugally Active Variable Magnetic Flux Alternator functions like a solid rotor design when up to high speed and becoming a gyro dynamic reactive mass (flywheel/gyroscope) as centrifugal force is generated.

The stored potential has a strong resistance to changing the axis of rotation, therefore offer gyroscopic stabilization within the initial generator design without the need or weight of additional components.

If there was a strong gust of wind suddenly applied to the wind turbine and if it had a dual solid rotor design, the turbine and tower would have gyroscopic stabilization.

The stored energy potential and inertia within a solid rotor design would provide gyroscopic stabilization due to the laws of Conservation of Angular Momentum.

Diverting some of its stored energy potential and inertia to place tremendous loading on the bearings, shafts and rotors in the energy conversion process due to the non-flexible rotor configuration.

The moveable magnets (3) within the rotors (26-27) and the other components in the rotors (26-27) of the Centrifugally Active Variable Magnetic Flux Alternator (with a sum of point mass moments of inertia) placed on the outer rim displays a flexible outer mass at the rim, presents a predetermined amount of angular momentum within the design.

Exhibiting a strong progressively increasing resistance to changing the axis of rotation as rotor speed increases, allowing the moveable magnets to move above and below in respect to the horizontal line of the rotor.

After a predetermined processing force is applied to the machine, it over powers the stored energy potential and inertia within the moveable rotors (acting like solid rotors) and then the rotors moveable magnets (3) would start to move away from the centerline, giving into this processing force.

This bending of the rotors reduces the gyroscopic stabilization effect and enables a buffering/shock absorbing system that the solid rotors can not display and minimizing the loading on the bearings, shaft and rotors for increased reliability and durability.

Once the sudden movement an angular momentum change dissipates, the moveable magnets (3) in the rotors (26-27) once again set back the point mass moments of inertia and configure into the solid like rotor design and gyroscopic stabilization is once again established.

With the capability of the machine to store and release the rotational kinetic energy from the rotors (26-27) (flywheels) makes this design unique and highly productive in the energy conversion process. Especially in very light wind conditions, producing electrical power below the startup speed of conventional wind turbine designs.

In very light wind conditions, the Next Generation Wind Turbine would be spinning, producing a minimum amount of electrical power but still moving and staying active. When there is a gust of wind, the flywheel design would spool up (taking in rotational kinetic energy) and spool down (releasing rotational kinetic energy) more slowly than conventional turbines designs with a non-flywheel design.

The conversion capability of the Centrifugally Active Variable Magnetic Flux Alternator with its large quantity of rotational kinetic energy capacity. This allows for a super lightweight turbine blade to be incorporated into the design for maximum durability and minimizes cost. This system exceeds the stored rotational kinetic energy capacity of the heavy rotors of conventional wind turbine designs for cleaner and steadier electrical power output.

This configuration offers a substantial increase capability in energy conversion, compared to conventional generator technology due to the design limitations.

The rotors mass with its moment of inertia and angular velocity in the Centrifugally Active Variable Magnetic Flux Alternator serves many purposes. The alternators rotors (26-27) are flywheels for energy absorbing and releasing of rotational kinetic energy. They also provide gyroscopic stabilization and provide a smother variation in electrical power vs. load.

This absorption and releasing of the rotational kinetic energy over a broader time period maximize the electrical output. Both in power and in quality compared to conventional wind turbine designs, even when incorporating there heavy turbine blade design to provide flywheel effect.

The heavy flywheel effect in the Centrifugally Active Variable Magnetic Flux Alternator also addresses the main drawback of a downwind design. It smoothens the fluctuations in the wind input power due to the blade passing through the wind shade of the tower.

### The Counter Rotating Double Horizontally Driven Pendulum:

The gyroscopic stabilization is also assisted by a double horizontally driven counter rotating pendulum for an extremely unusual but very useful dynamical system.

There are 12 lead ball weights (43) in each one of the two rotors; they are attached half way out from the axis to the rotors rim of the two counter rotating rotors (26-27) in the Centrifugally Active Variable Magnetic Flux Alternator.

The lead weights (43) are solidly connected to a small rod, the other end of the rod is attached to the middle pendulum bearing (44). The direction of movement of the middle pendulum bearing (44) is from the axis to the edge of the rotor rim.

There is a top pendulum bearing (45) attached to the rotor on one end and connected to another small rod at the other end, which connects the middle pendulum bearing (44).

The direction of movement of the top pendulum bearing (45) is also from the axis to the edge of the rotor rim. The middle bearing also acts like a weight due to its mass but is lighter than the lead weight, producing a double pendulum system.

The pendulum differs from the strong resistance to changing the axis of rotation from the gyroscopic stabilization system previously mentioned. The double pendulum displays a resistance to changing lateral moment for a stable platform.

The horizontally counter rotating double driven pendulum also exhibits angular momentum, moment of inertia and the differential moment of inertia similar to the gyroscopic stabilizing system.

The pendulum system functions by changing the moment of inertia of the point mass with respect to the axis. Whereas the gyroscopic stabilization comes from a progressively increasing resistance to changing the axis of rotation as rotor speed increases allowing the moveable magnets (3) to move above and below in respect to the horizontal line of the rotors (26-27).

The stored energy potential (kinetic energy) and inertia within the 24 metal rods, the 12 lead weights (43) and 24 bearings (44-45) attached to the rotor provide the pendulum stabilization. This is due to the fundamental constraints of conservation laws, the Conservation of Momentum, Conservation of Angular Momentum and ect.

If there was a rapid lateral force applied to the turbine (12:00 position), on the clockwise rotor, the lead weights that are positioned of the direction of the movement rapid lateral force (6:00 position) moves slightly in towards the axis.

This is due to the lateral force pushing the axis (rotor shaft) towards the rim of the rotor in the direction of the movement of the rapid lateral force and the mass of the weights are forced closer to the axis from the force applied. The bearings (44-45) enable the movement of the lead weights (43) to change rotational distance from the axis.

180 degrees on the same rotor the lead weights (43) that are in the same direction (12:00 position) of the rapid lateral force moves slightly outward away from the axis.

This is due to the lateral force pushing the axis (rotor shaft) away from the rim of the rotor in the opposite direction of the movement of the rapid lateral force and the mass of the lead weights (3) are forced further from the axis from the force applied. The bearings (44-45) enable the movement of the lead weights (43) to change rotational distance from the axis.

Since the rotor (26) is spinning clockwise, the angular velocity vector (input shaft to rotor) is displaying the external input torque. The mass of the lead weights (43) in the direction of the movement of the rapid lateral force (6:00 position), are forced closer to the axis, displaying a moment of inertia of the point mass with respect to the axis.

180 degrees on the same rotor, the angular velocity vector (input shaft to rotor) is displaying the external input torque.

The mass of the lead weights (43) in the opposite direction of the movement of the rapid lateral force (12:00 position) are forced further from the axis, displaying a moment of inertia of the point mass with respect to the axis.

The angular momentum of the lead weights (43) are the same all around. The weights that are moved closer to the axis want to speed up and the weights that are further from the axis wants to slow down to as per Kepler's law.

The lead weights that moved closer to the axis trying to force an increased speed to the rotor and the lead weights (43) that moved from the axis trying to force a reduced speed to the rotor, cancel each other out with no net increase or decrease of rotor speed.

The angular velocity vector (input shaft to rotor) spinning clockwise now forces the rotor (26) to spin at the constant input speed. The lead weights that moved further away from the axis display a directional linear thrust in the opposite direction of the rapid lateral force (12:00 position). The lead weights (43) that moved closer to the axis display a directional linear thrust in the same direction of the rapid lateral force (6:00 position).

The force from the lead weights (43) that moved further from the axis display greater directional linear thrust (12:00 position), due to the same mass being accelerated further from the axis.

This places increased mechanical leverage on the input shaft (26) vs. the weights that moved closer to the axis displaying reduced directional linear thrust (6:00 position), due to the same mass being propelled closer to the axis. This places decreased mechanical advantage on the input shaft.

The counter clockwise (27) rotor operates the same except, the rotation is reversed with the same produced directional linear thrust in the direction of the rapid lateral force (12:00 position). This device is an example of where there is an action (rapid lateral force) there is an equal and opposite reaction (directional linear thrust), per Newton's law.

This offset balance of directional linear thrust from the lead weights shifting in respect to the axis of the dual rotors, is the bases of the horizontally counter rotating double driven pendulum stabilization system.

The spin of the rotors (26-27) self correct the movement of mass of the lead weights (43) and then repositioned back to the original distance from the axis.

The kinetic energy of the device is the sum of the kinetic energy of the center of mass of each of the rods, bearings and lead weights and the kinetic energy about the centers of the mass of the rods, bearings and lead weights.

Once the sudden movement an angular momentum change dissipates, the lead weights once again set back the point mass moments of inertia. The pendulum stabilization is once again established, ready for the next rapid lateral force to be applied.

Modifications to these embodiments can be done to the extent as to still be within the vision set forth in the following claims.

What I claim:

1. A wind turbine alternator for producing electrical output, comprising; two but not limited to, counter rotating lightweight rotors (26-27), said rotors having 12 but not limited to moveable magnets (3) in them, said moveable magnets (3) are permanent magnets exhibiting strong and highly isolated concentration of the North pole and South pole magnetic flux density, the movable magnets (3) provides a variable range of motion to constantly change the amount of magnetic flux density from the movable magnets (3) to the two stators one per said counter rotating rotor, each stator includes 12 but not limited to liquid cooled or air cooled electrically conductive windings ie: stepped stator coils (2);

2. The wind turbine alternator of claim 1, wherein: a differential mechanism (22) is between the two rotors (26-27) and are directly connected, enabling the two said rotors (26-27) to spin in opposite directions ie; counter rotate; the said counter rotating rotors (26-27) being capable of rotating at a variable rotational velocity by consistent or inconsistent input power; the air gap between the said counter rotating rotors (26-27) and said stepped stator coils (2) is variable, the said variable gap is changed by the increase or decease in said counter rotating rotors (26-27) rotational velocity; within each one of the said counter rotating rotors (26-27), each one of the said moveable magnets (3) is attached to a shaft bearing (8) that operates as a fulcrum and there are adjustable counter weights (9) opposite each one of the said moveable magnets with the said shaft bearing (8) in the middle.

3. The wind turbine alternator of claim 2, wherein: said means comprises a centrifugal force being produced from the rotational velocity of the said rotors (26-27) and acting on said moveable magnets (3) that start in the low power position on the stepped stator coils (2) when stopped or marginal centrifugal forces are produced; the said moveable magnets (3) are down from the said rotors (26-27) center line, said centrifugal force increases as the rotational velocity increases in the said rotors (26-27); said increased centrifugal force progressively moves the moveable magnets (3) up from the bottom low power position on the said stepped stator coils (2) to the middle power position on the stator coils (2); when said centrifugal force increases even further, the moveable magnets (3) move up from the middle power position on the said stepped stator coils (2) towards the center line of the said rotors (26-27), high power position on the stepped stator coils (2); said center line would be in the position similar to a conventional generator rotor with a solid rotor; when said centrifugal forces are reduced, the moveable magnets (3) proceed from the high power position on the stepped stator coils (2) to the middle power position on the stepped stator coils (2); when said centrifugal forces are even further reduced the moveable magnets (3) move from the middle power position to the low power position on the stepped stator coils (2); this variable centrifugal force enables full range of motion of the moveable magnets (3) from low to medium to high, back to medium to low power levels by said rotational velocity of the rotors (26-27).

4. The two said stators and said counter rotating rotors are concentric, with the said movable magnets (3) in each of the said counter rotating rotors (26-27) when the moveable magnets (3) are in the lowest position of movement, enables low electrical output mode, in this position the said moveable magnets (3) in both said rotors (26-27) have the largest air gap between the said moveable magnets (3) and the two said stepped stator coils (2) and provides the lowest magnetic flux density to the two said stators.

5. When the moveable magnets are in the middle position of movement, enables medium electrical output mode, in this position the said moveable magnets (3) in both said rotors (26-27) have a smaller air gap between the said moveable magnets (3) and the two said stepped stator coils (2) and provides a moderate amount of magnetic flux density to the two said stator coils (26-27).

6. When the moveable magnets are in the highest position of movement, enables maximum electrical output mode, in this position the said moveable magnets (3) in both said rotors (26-27) have an even smaller air gap between the said moveable magnets (3) and the two said stepped stator coils (2) and provides substantial amount of magnetic flux density to the two said stator coils (26-27).

7. The two said stators and said counter rotating rotors are concentric and the rotors (26-27) rim diameter is keep uniformed by means of over speed outer and inner magnets (5-7) functioning in a repulsion mode facing like pole towards each other and held in place by means of outer and inner magnet holder shafts (4-6); when the moveable magnets are in said highest position of movement and additional back EMF is required for braking action so not to over speed the alternator, the rotors rotational speed will start to exceed a predetermined centrifugal force level; said centrifugal force on the rotors (26-27) outer rim components cause the over speed outer and inner magnets (5-7) to move closer from the outward stretching action of the outer rim components; said moveable magnets (3) to the stepped stator coils (2) now have the smallest air gap, for the highest level of magnetic flux density and electrical output power.

8. The wind turbine alternator, wherein: The said adjustable counter weights (9) can be electrically controlled by the electronic control box (29) or manually set by the adjustable counter eight locking nut (11) to enable different engagement speeds of the said movable magnets (3) from the rotational velocity of said rotors (26-27); said engagement speeds of the said moveable weights (3) and said centrifugal force placed on the said rotors (26-27) progressively changes the said variable gap, by moving the said moveable magnets (3) up towards the center line by means of the increased rotational velocity of said rotors (26-27) and closer to the said stepped stator coils (2); then by decreasing the rotational velocity of the rotors (26-27) the said moveable magnets (3) proceed down away from the center line of the rotors (26-27) moving further away from the said stepped stator coils (2).

9. The wind turbine alternator of claim 4, wherein: The alternators said electrical output and rotational velocity is self regulating by the input shaft power, said moveable magnets (3) have an adjustable engagement speed proportional to rotational velocity of the rotors (26-27) and the said adjustable counter weights (9); and said means of producing variable electrical output power over the entire said operating range, from the said engagement speed, the lowest said electrical output power when the said moveable magnets (9) are at the maximum distance from the stepped stator coils (2) up to the maximum electrical output when the said moveable magnets reach the said center line in the said two counter rotating rotors (26-27).

10. The wind turbine alternator of claim 9, wherein: said variable electric output power is in the form of alternating current, by means of changing magnetic poles every other said moveable magnet (3) ie: North pole on top and a South pole on bottom of the moveable magnet (3) then a South pole on top and a North pole on the bottom of the moveable magnet (3), ect all the way around all the two said rotors (26-27); this reverses the magnetic flux direction to the stepped stator coils (2) every time the said moveable magnets (3) pass each one of the 12 stepped stator coils (2), to produce said alternating current and can be configured into but not limited to; single phase or three phase electrical output.

11. The wind turbine alternator, wherein: the distance of the said stepped stator coils (2) angles down the same distance as the said moveable magnets (3) movement up and down; said stator coils have progressive steps in the area that absorbs the magnetic flux from the moveable magnets (3); therefore varying the distance from the stepped stator coils (2) and the moveable magnets (3); enabling an adjustable air gap and flux density between the stator coils and the moveable magnets (3).

12. The wind turbine alternator, wherein: said moveable magnets (3) generates a said magnetic field having a said pole order; the said engagement speed and the amount of electrical output is directly controlled by two factors, one is the said rotational velocity of the two said rotors (26-27) and the other is the placement of the said adjustable counter weights (9); the closer the said adjustable counter weights (9) are to the shaft bearings (8) (fulcrum), the higher the rotor rotational velocity and generated centrifugal force placed on the two said rotors (26-27) is needed to overcome the mass to the said moveable magnets (3) from the lowest position to the highest position, the closer the said adjustable counter weights (9) are to the shaft bearing (8) (fulcrum), the higher the rotational velocity and generated centrifugal force placed on the two said rotors (26-27), to overcome the mass to the said moveable magnets (3) from the lowest position to the highest position.

13. The wind turbine alternator of claim 1, wherein: said rotors (26-27) with the said moveable magnets (3) and said adjustable counter weights (9) display gyroscopic stabilization as a byproduct when the Centrifugally Active Variable Flux Generator is operating at high speeds; at high rotor rotational velocity said moveable magnets (9) can suddenly shifted away from the said centerline by means of external lateral acceleration ie; wind gust against the turbine, said rotors (26-27) point mass changes from the force of the said lateral acceleration; said moveable magnets (9) reset back to the centerline from centrifugal force produced from the said rotor rotational velocity and total gyroscopic stabilization is once again established.

14. The wind turbine alternator of claim 1, wherein: said light weight rotors (26-27) require a predetermined amount of store energy potential to meet the criteria of the next generation wind turbines; much of the mass in the said rotors (26-27) are the said moveable magnets (3), said adjustable counter weights (9) and said shaft bearing (8) systems also 12 but not limited to heavy material weights (43) per rotor; each heavy material weight (43) is connected to a solid shaft; then a one way bearing (44) allowing movement from the axis to the outer rim of the said rotors (26-27); then another small shaft and another one way bearing (45) allowing movement from the axis to the outer rim of the said rotors (26-27); providing a built in counter rotating double horizontally driven pendulum; instead of the required rotor mass (26-27) to inactive as in conventional motor/generator rotor technology, the required rotor (26-27) mass is strategically placed in the moving components of said rotors (26-27) ie; said moveable magnets (3), said adjustable counter weights (9), said shaft bearing (8) systems and said heavy material weights (43) becoming a gyro dynamic reactive mass (flywheel/gyroscope) when rotors (26-27) rotational velocity increases and as centrifugal force is generated.
